(19) United States
(12) Patent Application Publication
(10) Pub. No.: US 2017/0225274 A1
(43) Pub. Date: Aug. 10, 2017

(54) COMPENSATING FOR VARIATIONS IN WELDING

(71) Applicant: Lincoln Global, Inc., City of Industry, CA (US)

(72) Inventors: Steven Peters, Huntsburg, OH (US); Eric Stewart, Girard, PA (US); Jason Matthews, Chardon, OH (US)

(21) Appl. No.: 15/018,263

(22) Filed: Feb. 8, 2016

(51) Int. Cl. B23K 31/12; G01N 29/04; G01N 29/26; B23K 9/095; G01B 17/02

(52) U.S. Cl. CPC B23K 31/12; B23K 9/0956; G01B 17/02; G01N 29/26; G01N 29/04; G01N 2291/263

(57) ABSTRACT

A system for identifying variations at a weld location and accommodating for the variations. The system includes two sensors positioned on each side of a welding location, with a welding device at the welding location. The sensors each emit a signal toward the welding location and receive feedback from the signal that indicates the shape and size of the welding surfaces at the welding location. The sensor information, along with the exact locations and orientations of the sensors, is utilized to determine whether one or more welding parameters should be adjusted.

### FIELD OF THE INVENTION

The present invention relates generally to automated and semi-automated welding systems and particularly for compensating for irregularities in weld surfaces.

### BACKGROUND OF THE INVENTION

When performing a weld, either with an automated system or with a semi-automated system, irregularities are often encountered with respect to the weld surfaces. In some instances, a gap may be present between two surfaces, two welding surfaces may not be flush, and/or irregularities in the thickness of one or both welding surfaces may require adjustments in welding technique. For example, the edge of a surface that is designed to be a straight edge may varying slightly along the welding edge and/or may vary in thickness. To compensate for irregularities, a welder may need to adjust one or more parameters of the welding device and/or may need to reposition the welding device to ensure a proper weld.

### SUMMARY OF INVENTION

While welding, adjustments may be required based on variations in the welding surfaces. For example, all welding surfaces may not be identical, even if manufactured to be identical. Welding surfaces may be thicker in some instances, have slightly uneven edges, and/or other variations. Further, in some instances, two welding surfaces may not always exactly align at the weld location. Although a welder may be able to make adjustments while welding based on observation of the weld location, variations may be too minor to identify visually and/or the welding may be performed robotically, in which case a human may not be observing the weld location continuously. Without adjusting the welding device to compensate for variations, finished welded products may be compromised and/or unusable.

To allow for variations at a welding location, the disclosed device identifies variations at the welding location and provides indications of required adjustments so that a welding device may be reoriented and/or one or more parameters adjusted to compensate for the variations. For example, sensors, such as phased arrays, may be placed on either side of a weld, with each sensor emitting a signal and receiving feedback indicating the shape, size, and/or thickness of the welding surface at the current weld location. Further, additional sensors may identify the current orientation of the sensors to be used to further identify, for example, whether there is a gap between the welding surfaces, whether one surface is oriented higher than the other surface, and/or whether one or both of the surfaces is angled. The sensor information and sensor location information may then be utilized to determine whether one or more parameters may need to be adjusted, such as the current of the welding device, the angle of approach of the welding device, the type of weld to be performed, and/or one or more other variations that a welder may other perform manually if the welder were to identify a variation.

In one embodiment, a welding system is provided and includes: two scanning devices arranged to emit a scanning signal towards an area of a welding assembly adjacent to a location to be welded, a processor, and a welding device. The processor is operable to obtain data from the scanning devices, the data indicative of a configuration of the welding assembly near the location to be welded. Further, the processor is operable to identify a variation in the welding surface by comparing the configuration of the welding assembly near the location to be welded to a pre-defined configuration. Still further, the processor is operable to determine an adjustment to the welding device based on the variation.

In some embodiments, the scanning devices are ultrasonic probes, wherein each ultrasonic probe may be a phased array, and the data may include ultrasonic data received from the one or more ultrasonic probes.

In some embodiments, the scanning devices include a first scanning device arranged to emit a first scanning signal toward the location to be welded through at least a portion of a first component of the welding surface; and a second scanning device arranged to emit a second scanning signal toward the location to be welded through at least a portion of a second component of the welding surface.

In some embodiments of the system, the welding device may be controlled by an operator; and an indication of the adjustment may be provided to the operator while the operator is performing a weld. In some of those embodiments, the indication is at least one of an audio indication and a visual indication.

In some embodiments, the processor automatically performs the adjustment to the welding device. In some of those embodiments, the welding device is controlled by the processor.

In some embodiments, the variation is a gap between two parts of the welding surface; and the adjustment is increasing the width of the weld to compensate for the gap.

In some embodiments, the variation may be a change in thickness of the welding surface; and the adjustment may be a change in a current provided to the welding device during welding.

In some embodiments, the processor may identify the variation before a weld is started.

In some embodiments, the processor may identify the variation while a weld is being performed.

In a second embodiment, method of determining an adjustment to a weld is provided and includes the steps of receiving, via a plurality of ultrasonic probes, ultrasonic data indicative of a current configuration of a welding surface where a weld is to be performed; identifying a pre-defined configuration for the welding surface, the pre-defined configuration indicative of an acceptable configuration that is free of variations; determining, based on the current configuration and the pre-defined configuration, a variation in the current configuration, wherein the variation is not present in the pre-defined configuration; and determining an adjustment to the weld based on the variation.

In some of those embodiments, the method may further includes the step of adjusting one or more settings of a welding device based on the adjustment; and the welding device may be utilized to perform the weld. In some versions of those embodiments, the adjustment may be a change of current of the welding device. In other versions of those embodiments, the adjustment may be a change in weld type.

Numerous aspects of the general inventive concepts will become readily apparent from the following detailed description of exemplary embodiments, from the claims and from the accompanying drawings.

### BRIEF DESCRIPTION OF THE DRAWINGS

In the accompanying drawings, which are incorporated in and constitute a part of the specification, embodiments of the invention are illustrated, which, together with a general description of the invention given above, and the detailed description given below, serve to illustrate exemplary embodiments of the general inventive concepts.

FIG. 1 is a block diagram of a weld variation compensation system according to an exemplary embodiment;

FIG. 2 is an illustration of two sensors that each emit signals to identify variations in two welding surfaces;

FIG. 3 is an illustration of an exemplary embodiment from above;

FIG. 4 is a diagram illustrating a mechanical configuration for determining the location of two sensors;

FIGS. 5A and 5B are illustrations of example configurations of the exemplary system when two welding surfaces are misaligned;

FIG. 6 is another illustration of an example configuration of the exemplary system when two welding surfaces are misaligned;

FIG. 7 is an illustration of an example configuration of the exemplary system when the edge of one of the welding surfaces is uneven; and

FIG. 8 is a block diagram of an example computer system.

### DETAILED DESCRIPTION

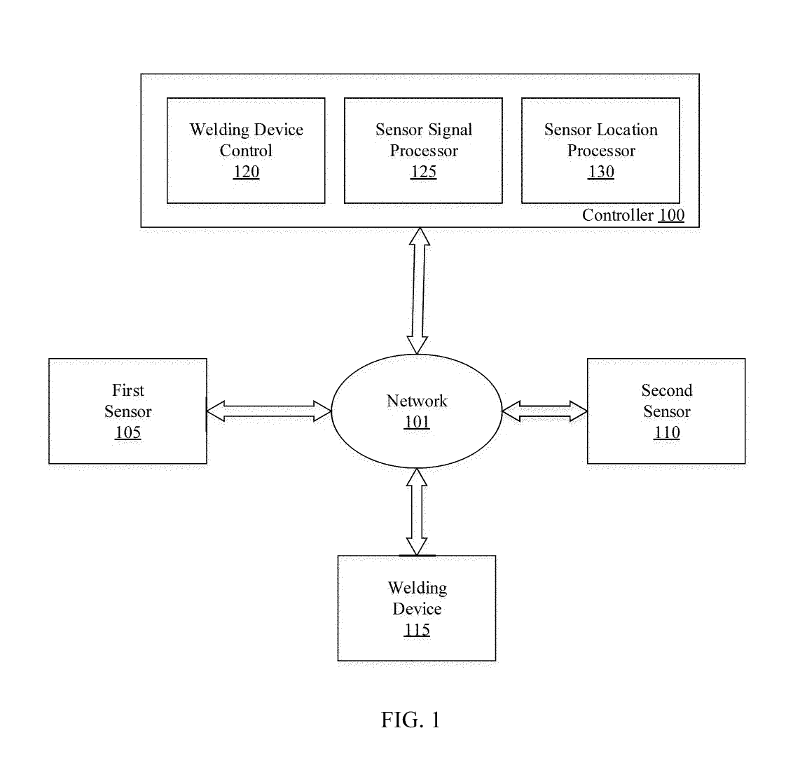

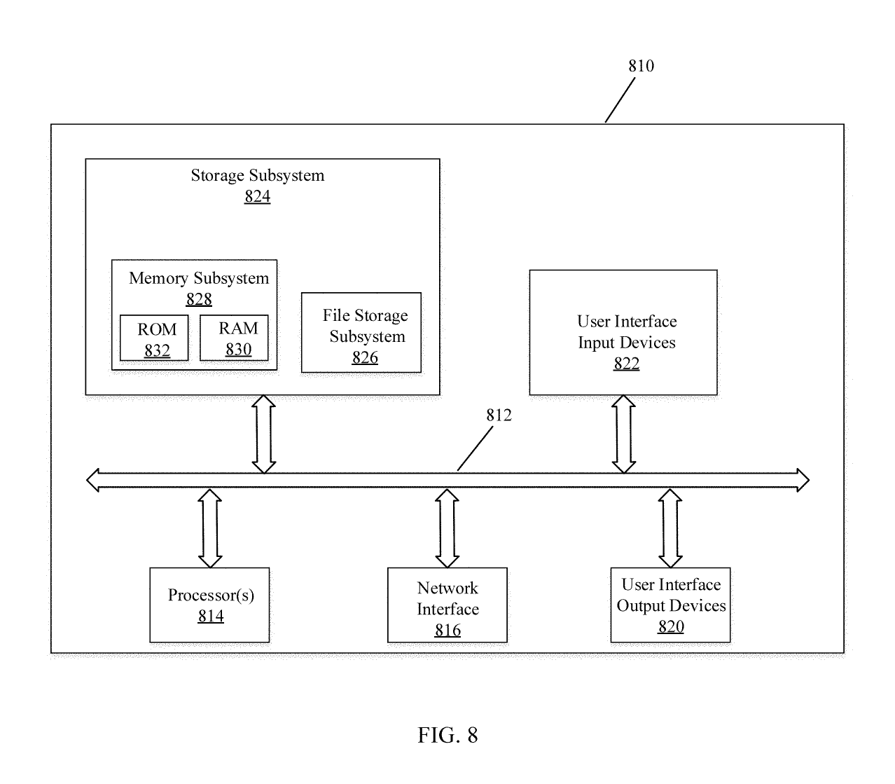

Referring now to the drawings, which are for the purpose of illustrating exemplary embodiments of the invention only and not for the purpose of limiting same, FIG. 1 discloses an exemplary system for accommodating for anomalies in weld surfaces. The system includes a controller 100, first sensor 105, second sensor 110, and a welding device 115. The controller includes a welding controller component 120, a sensor signal processor 125, and a sensor location processor 130. In some embodiments, the system may include one or more additional components, alternate components, and/or one or more components of the system illustrated in FIG. 1 may not be present or may be combined with other components. One or more of the components of FIG. 1, such as controller 100 and/or one or more of the components of controller 100, may be a computing system and/or share one or more characteristics with the computer system illustrated in FIG. 8 and described herein.

Welding device 115 may be an automated, semi-automated, or manual welding device. The welding device 115 may include a welding torch and a power supply for the welding torch. The welding device 115 may additionally include one or more interfaces to allow the welder to adjust parameters during the welding process. For example, the welding device 115 may include an interface to adjust the current that is being delivered to the welding torch during operation. In some embodiments, the welding device 115 may be in communication with the welding device controller 120, which may automatically adjust one or more parameters while the welder is performing an operation and/or while the welding device 115 is automatically performing a weld.

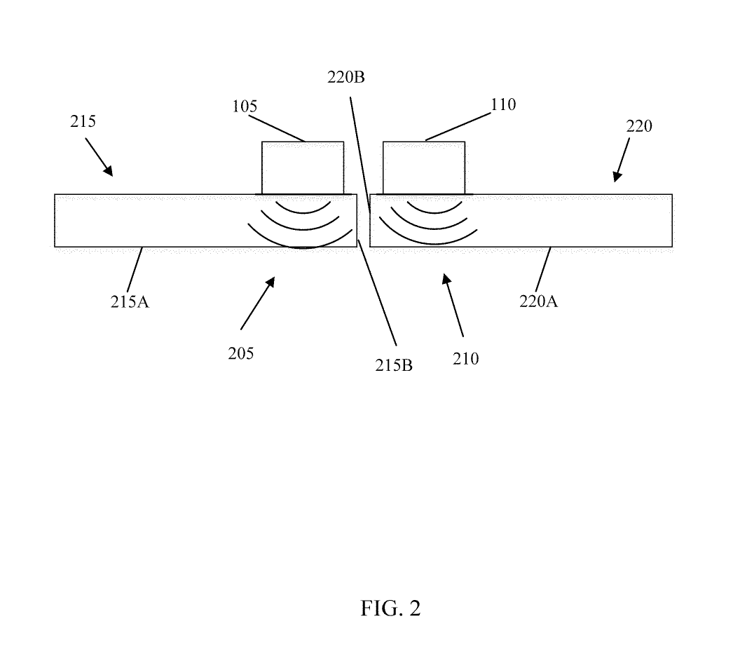

The first sensor 105 and second sensor 110 may each be one or more devices that are capable of identifying variations in welding surfaces. For example, first sensor 105 and second sensor 110 may emit one or more signals, such as a wave, that may penetrate a welding surface to detect one or more variations in the structures. For example, referring to FIG. 2, first sensor 105 may be placed directly on or proximate to first welding surface 215. Similarly, second sensor 110 may be placed on or proximate to second welding surface 220. First sensor 105 may emit a first signal 205, which first sensor 105 may utilize to identify, for example, variations in the thickness of first welding surface 215 by identifying a distance between the first sensor 105 and edge 215A. Also, for example, first sensor 105 may emit a signal 205 and utilize feedback from signal 205 to identify one or more variations in first welding surface edge 215B. Similarly, second sensor 110 may emit a second signal 210 and utilize feedback (such as reflection of the second signal 210) to determine variations in the thickness of second welding surface 220 (e.g., based on reflection of second signal 210 from edge 215B) or variations in edge 215B.

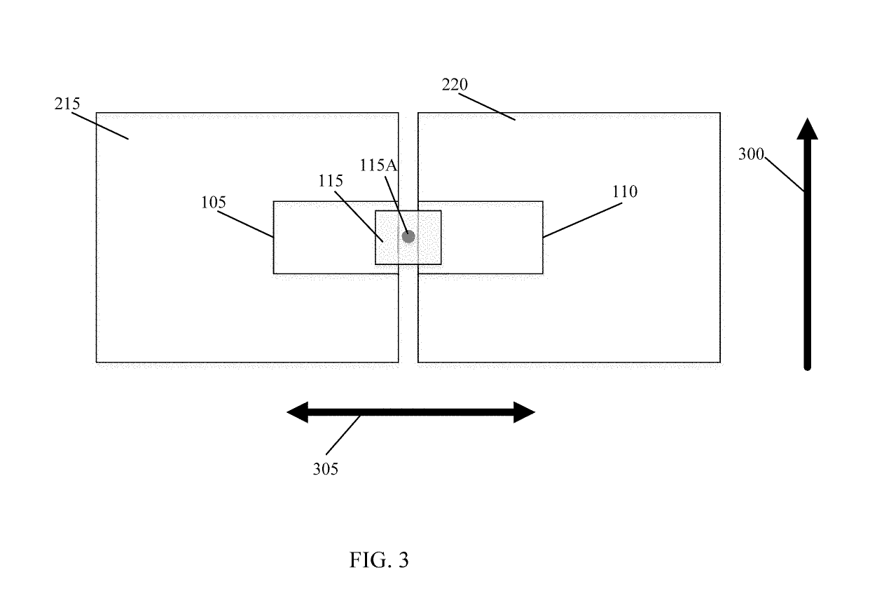

Referring to FIG. 3, an overhead view of the device is provided. The first welding surface 215 and second welding surface 220 are shown as abutting each other, with a slight gap between the surfaces where a weld is to be performed. The welding device 115 (shown with welding arc 115A) is positioned at the gap between the surfaces, with the first sensor 105 positioned above the first welding surface 215 (or resting upon the first welding surface 215). The second sensor 110 is position above (or resting upon) the second welding surface 220. As the weld is performed, the device, including the sensors and the welding device 115, may move along the gap between the surfaces, as indicated by the directional arrow 300. As the device moves, first sensor 105 and second sensor 110 emit signals (as illustrated in FIG. 2) and provide the signals to the sensor signal processor 125, which then determines whether any irregularities or variations at the current weld location requires adjustments to the welding device 115. If the welding device 115 requires adjustment, sensor signal processor 125 provides indications of the adjustments to the welding device controller 120 (as shown in FIG. 1), which then performs the necessary adjustments.

In some embodiments, sensor signal processor 125 requires identifying the exact positioning of the first sensor 105 and the second sensor 110. For example, sensor signal processor 125 may receive a signal from the first sensor 105 and may identify a variation in the first surface 215, such as a change in the thickness of the first surface or a variation in the edge of the first surface 215. However, because of variations in the surface of the first welding surface 215, the sensor may not always be positioned with the exact same orientation (e.g., variations in the top of the welding surface may cause the sensor to tilt and/or otherwise change position). Further, because the sensors may not penetrate past each side of the welding surfaces (i.e., the signals may stop at the edge of the surfaces), sensor signal processor 125 may require the exact location of both sensors to utilize those signals to identify a gap between the surfaces and/or a misalignment or warping of one of the surfaces.

In some embodiments, sensor location processor 130 identifies the exact positions of the first sensor 105 and the second sensor 110, and provides the locations to sensor signal processor 125. In some embodiments, sensor location processor 130 may include one or more sensors to detect the location and/or position of the first sensor 105 and the second sensor 110. For example, sensor location processor 130 may emit one or more signals (such as an ultrasonic wave), receive feedback from the emitted signals, and determine the locations and/or orientations of the first sensor 105 and second sensor 110 based on the feedback. In some embodiments, the sensors may send one or more signals to indicate position. For example, one or more gyroscopes, optical devices, and/or other instruments may be included in the housing of each of the sensors, and a component included with each of the sensors may send one or more signals to the sensor location processor to indicate changes in the orientation of the sensor (tilt, upward and/or downward movement, etc.). Additionally or alternatively, one or more additional sensors included with the housing of the first sensor 105 and second sensor 110 may communicate to determine the relative locations of the sensors to each other and provide the locations to the sensor location processor 130.

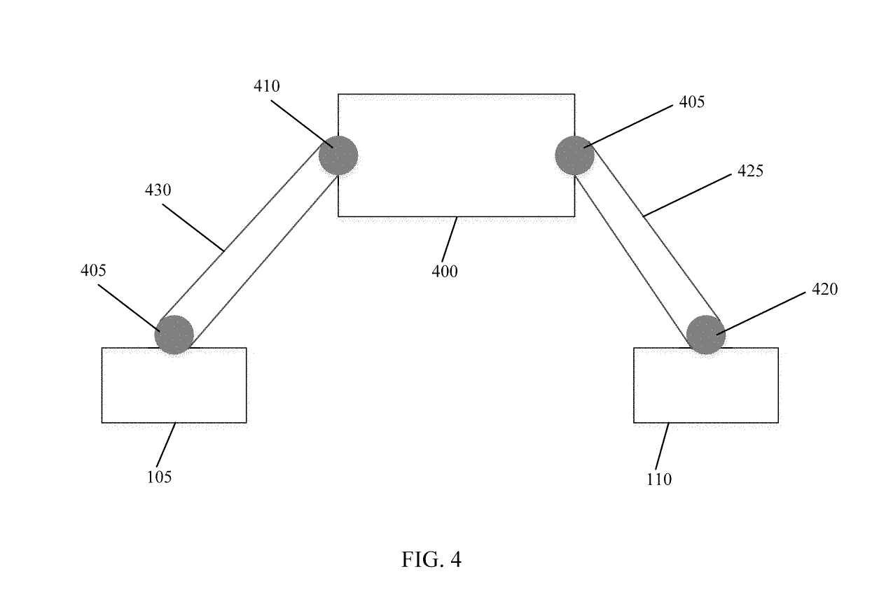

In some embodiments, one or more mechanical sensors may identify the locations of the first sensor 105 and the second sensor 110. For example, referring to FIG. 4, a mechanical configuration for determining the locations of the first sensor 105 and second sensor 110 is provided. Pivot point 405 is attached to the first sensor 105 and allows for freedom of movement in multiple planes, thus allowing first sensor 105, when resting on a welding surface, to freely tilt as needed based on changes in the welding surface. Similarly, pivot 410 may allow additional freedom of movement, such as when the welding material varies in thickness or shape. In some embodiments, sensors and/or measurement devices associated with pivot 405 and pivot 410 may measure changes in the position of first sensor 105 and provide sensor location processor 130 with measurements. Sensor location processor 130 may then determine the exact location and orientation of first sensor 105, and sensor signal processor 125 may utilize the determined location of first sensor 105 in conjunction with sensor data to identify variations in the welding surface at or near the welding location. Similarly, pivot 420 is attached to second sensor 110 and may move and measure movement to allow second sensor 110 to vary in position based on the welding material that it is resting on, and pivot 415 may further allow for movement in the second sensor 110 and measurement of any displacement from a reference position.

In some embodiments, first sensor 105 and/or second sensor 110 may be phased arrays. A phased array may be comprised on an antenna with a plurality of radiating elements each phased to emit a signal at a different phase. By shifting the phase of the radiating elements, constructive and destructive interference may be generated to steer the beam in a desired direction. For example, referring again to FIG. 3, first sensor 105 and second sensor 110 may be phased arrays. As the welding device and sensors are moving in the direction 300, the sensors may be emitting signals via phased arrays that may steer the beams back and forth in the scanning directions 305.

In some embodiments where the sensors are phased arrays, one or more components, such as sensor signal processor 125, may receive reflected signals from the first sensor 105 and the second sensor 110, and determine the current shape of the first surface 115 and the second surface. For example, sensor signal processor 125 may receive the feedback signals from the sensors and determine the thickness of each surface and/or the shape of the welding edge of each of the surfaces.

Sensor signal processor 125 determines the location of first sensor 105 and second sensor 110. In some embodiments, sensor signal processor 125 receives sensor information from first sensor 105 and second sensor 110, and utilizes the sensor information to determine whether adjustments are required to the welding device 115. For example, first sensor may emit a signal, receive feedback from the signal (such as reflection of a wave), and relay the feedback to sensor signal processor 125. Similarly, second sensor 110 may emit a signal, receive feedback, and send the feedback to sensor signal processor 125. Sensor signal processor 125 may then determine, based on the sensor feedback, whether one or more variations in the welding surfaces requires adjustments to the welding device 115.

In some embodiments, sensor signal processor 125 further determines the exact location of the first sensor 105 and the second sensor 110. The exact locations of the sensors may be required to determine whether a variation is present at the welding location. In some embodiments, the sensor location engine 130 may receive signals from one or more measurement instruments associated with the sensors 105 and 110, such as the pivots illustrated in FIG. 4. In some embodiments, sensor signal processor 125 may receive signals from one or more other sensors that may identify the exact locations of the first sensor 105 and the second sensor 110.

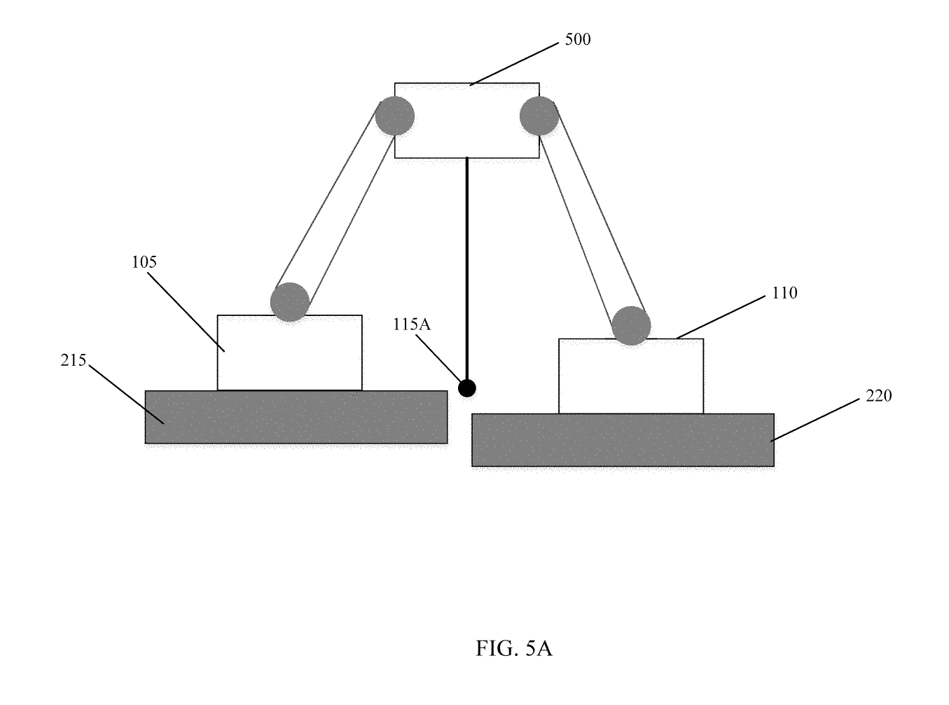

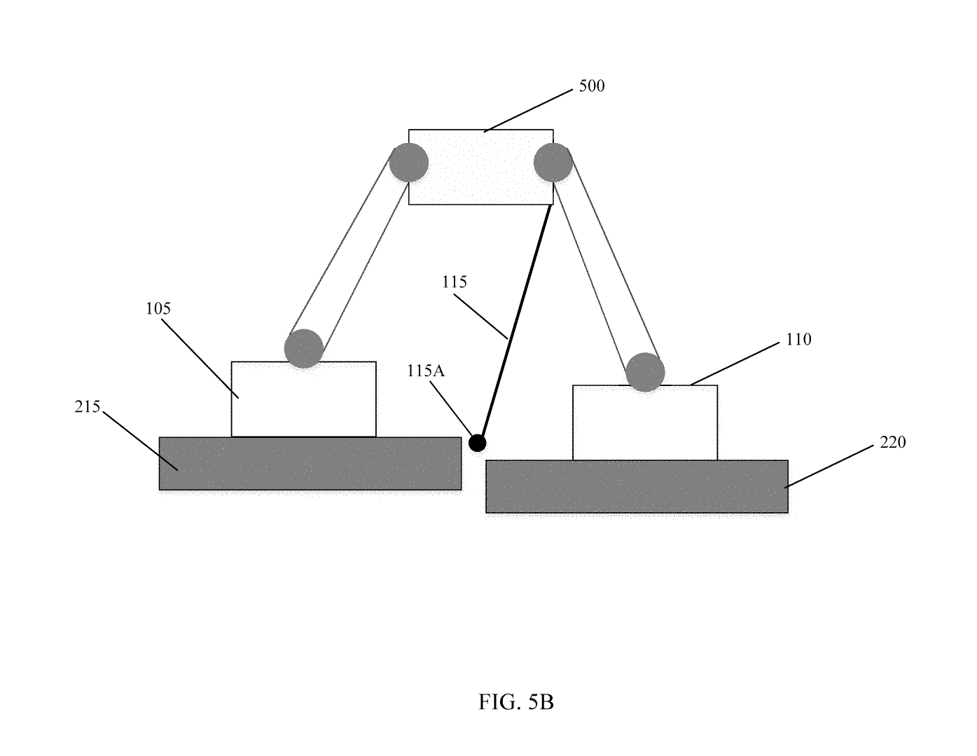

Referring to FIG. 5, a illustration of misaligned welding surfaces is provided. First sensor 105 is resting on first welding surface 215 and second sensor 110 is resting on second surface 220. In the illustrated example, first surface 215 is oriented closer to the device 500 than second surface 220 (misalignment is exaggerated for illustration purposes). This may be because, for example, warping in the first surface 215 and/or the second surface 220, manufactured variations in the surfaces, and/or one or more other irregularities that prevent the first surface 215 and the second surface 220 from meeting evenly at the welding device location 115. First sensor 105 may be emitting and receiving signals to indicate other variations in first surface 215, and second sensor 110 may be emitting and receiving signals to indicate other variations in the second surface 220 (differences in thicknesses, irregularities in the surface, etc.), as illustrated in FIG. 2. The welding device 115 with welding arc 115A are oriented for an aligned weld; that is, a weld without a variation as illustrated.

In some embodiments, sensor location processor 125 may determine that the welding surfaces are misaligned based on the identified locations of the sensors 105 and 110. Sensor location processor 125 may then provide welding device control 120 with an indication of the orientation of the welding surfaces. Welding device control 120 may then adjust the welding device 115 to compensate for the orientation of the welding surfaces. For example, welding device control 120 may change the angle of the welding device 115, increase and/or decrease one or more electrical parameters, and/or otherwise adjust the welding process based on the positions of the welding surfaces. As an example, based on the positions of the welding surfaces illustrated in FIG. 5, welding device control 120 may adjust the welding device 115 so that the welding arc 115A is positioned closer to the higher of the misaligned surfaces. In the illustrated configuration, the welding device 115 is reoriented to place the welding arc 115A closer to the first welding surface 215.

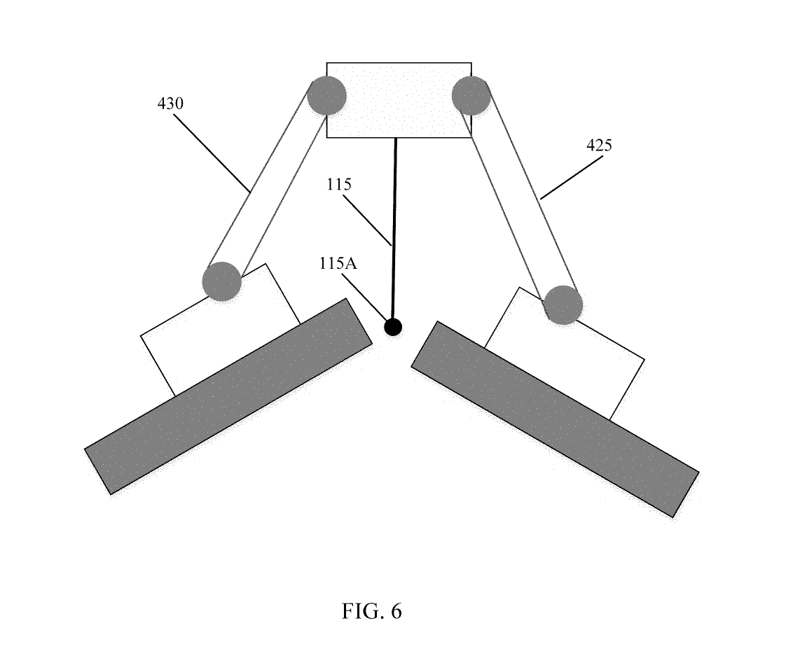

Referring to FIG. 6, another position of the welding surfaces is provided. In the illustrated configuration, both welding surface 215 and welding surface 220 are positioned such that the edges of welding surfaces nearest each other are angled upward at the welding device 115. In some embodiments, the device 100 may include pivots, as illustrated in FIG. 4, which allow for the sensors to be positioned as illustrated in FIG. 6. The pivots may measure the angles of the support arms 425 and 430, and further measure the angles of first sensor 105 and second sensor 110. In some embodiments, sensor location processor 130 may provide sensor signal processor 125 with the orientation of the sensors, and sensor signal processor 130 may then determine the orientation of the welding surfaces based on the sensor positions and the sensor information (i.e., reflections of waves from the sensors). In some embodiments, sensor signal processor 125 may provide an indication of the welding surface orientations to the welding device controller 120, which may adjust one or more parameters of the welding device 115, such as changing the current and/or voltage, adjusting the angle and/or orientation of the welding device 115).

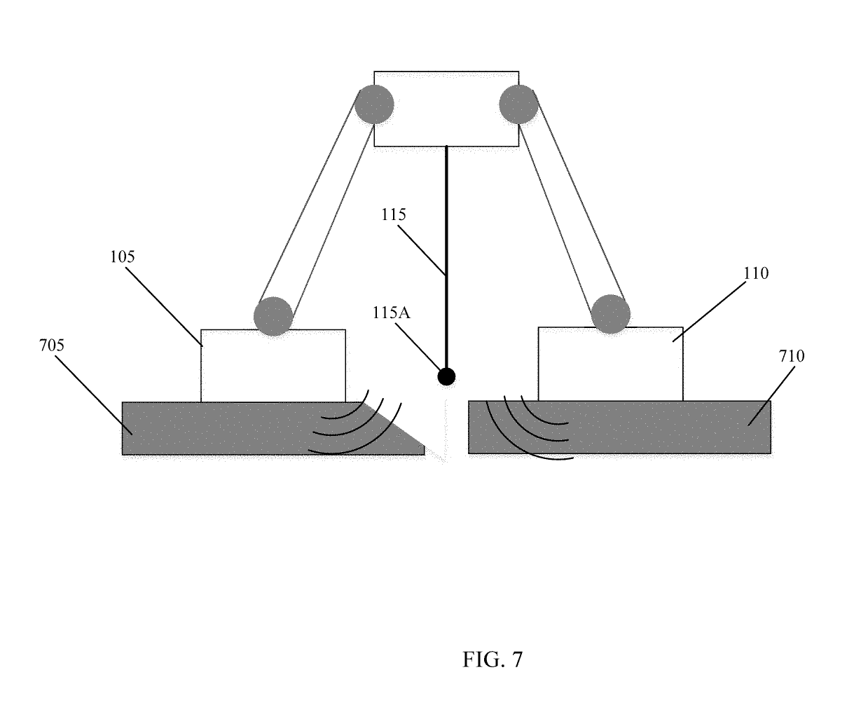

Referring to FIG. 7, an example of welding surfaces with changes in the thickness at the welding location is provided. In the illustrated example, a gap is present at the welding location, which may require one or more adjustments while welding. For example, first welding surface 705, rather than having a straight edge at the welding surface, has an angled edge. This angle may be intentional, due to a manufacturing defect, and/or may be a result of previous welds that have caused the edge to be angled. In some embodiments, the sensor 105 may emit a signal, and the reflection of the signal may be received by sensor 105 and provided to sensor signal processor 125, which may identify a change in the weld surface edge. Sensor signal processor may then provide an indication of the change in the weld edge to welding device controller 120, which may make an adjustment to the welding device 115, such as adjusting the penetration of the weld to ensure the root of the joint (i.e., the side of the weld joint where the surfaces are closest together) is welded and not the area of the joint where the surfaces are farther apart.

FIG. 8 is a block diagram of an example computer system 810. Computer system 810 typically includes at least one processor 814 which communicates with a number of peripheral devices via bus subsystem 812. These peripheral devices may include a storage subsystem 824, including, for example, a memory subsystem 826 and a file storage subsystem 828, user interface input devices 822, user interface output devices 820, and a network interface subsystem 816. The input and output devices allow user interaction with computer system 810. Network interface subsystem 816 provides an interface to outside networks and is coupled to corresponding interface devices in other computer systems. For example, controller 100 may be a computer that shares one or more characteristics with computer system 810 and may be, for example, a conventional computer, a digital signal processor, a handheld device such as a smartphone and/or tablet, and/or other computing device.

User interface input devices 822 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the tem). “input device” is intended to include all possible types of devices and ways to input information into computer system 810 or onto a communication network.

User interface output devices 820 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 810 to the user or to another machine or computer system.

Storage subsystem 824 stores programming and data constructs that provide the functionality of some or all of the modules described herein. For example, the storage subsystem 824 may include the logic to identify variations in a welding location and adjust a welding device to accommodate the identified variations.

These software modules are generally executed by processor 814 alone or in combination with other processors. Memory 826 used in the storage subsystem can include a number of memories including a main random access memory (RAM) 830 for storage of instructions and data during program execution and a read only memory (ROM) 832 in which fixed instructions are stored. A file storage subsystem 828 can provide persistent storage for program and data files, and may include a hard disk drive, a floppy disk drive along with associated removable media, a CD-ROM drive, an optical drive, or removable media cartridges. The modules implementing the functionality of certain embodiments may be stored by file storage subsystem 828 in the storage subsystem 824, or in other machines accessible by the processor(s) 814.

Bus subsystem 812 provides a mechanism for letting the various components and subsystems of computer system 810 communicate with each other as intended. Although bus subsystem 812 is shown schematically as a single bus, alternative embodiments of the bus subsystem may use multiple busses.

Computer system 810 can be of varying types including a workstation, server, computing cluster, blade server, server farm, or any other data processing system or computing device. Due to the ever-changing nature of computing devices and networks, the description of computer system 810 depicted in FIG. 8 is intended only as a specific example for purposes of illustrating some embodiments. Many other configurations of computer system 810 are possible having more or fewer components than the computer system depicted in FIG. 8.

The above description of specific embodiments has been given by way of example. From the disclosure given, those skilled in the art will not only understand the general inventive concepts and attendant advantages, but will also find apparent various changes and modifications to the structures and methods disclosed. For example, alternative methods and/or systems with additional or alternative components may be utilized to determine the orientation of an assembly relative to a welder. It is sought, therefore, to cover all such changes and modifications as fall within the spirit and scope of the general inventive concepts, as defined by the appended claims, and equivalents thereof.

1. A welding system, comprising:
two scanning devices arranged to emit a scanning signal towards an area of a welding assembly adjacent to a location to be welded;
a processor; and
a welding device;
wherein the processor is operable to obtain data from the scanning devices, the data indicative of a configuration of the welding assembly near the location to be welded;
wherein the processor is operable to identify a variation in the welding surface by comparing the configuration of the welding assembly near the location to be welded to a pre-defined configuration; and
wherein the processor is operable to determine an adjustment to the welding device based on the variation.

2. The system of claim 1, wherein the scanning devices are ultrasonic probes, wherein each ultrasonic probe is a phased array, and wherein the data includes ultrasonic data received from the one or more ultrasonic probes.

3. The system of claim 1, wherein the scanning devices includes:
a first scanning device arranged to emit a first scanning signal toward the location to be welded through at least a portion of a first component of the welding surface; and
a second scanning device arranged to emit a second scanning signal toward the location to be welded through at least a portion of a second component of the welding surface.

4. The system of claim 1,
wherein the welding device is controlled by an operator; and
wherein an indication of the adjustment is provided to the operator while the operator is performing a weld.

5. The system of claim 2, wherein the indication is at least one of an audio indication and a visual indication.

6. The system of claim 1,
wherein the processor automatically performs the adjustment to the welding device.

7. The system of claim 4, wherein the welding device is controlled by the processor.

8. The system of claim 1,
wherein the variation is a gap between two parts of the welding surface; and
wherein the adjustment is increasing the width of the weld to compensate for the gap.

9. The system of claim 1,
wherein the variation is a change in thickness of the welding surface; and
wherein the adjustment is a change in a current provided to the welding device during welding.

10. The system of claim 1, wherein the processor identifies the variation before a weld is started.

11. The system of claim 1,
wherein the processor identifies the variation while a weld is being performed.

12. A method of determining an adjustment to a weld, comprising:
receiving, via a plurality of ultrasonic probes, ultrasonic data indicative of a current configuration of a welding surface where a weld is to be performed;
identifying a pre-defined configuration for the welding surface, the pre-defined configuration indicative of an acceptable configuration that is free of variations;
determining, based on the current configuration and the pre-defined configuration, a variation in the current configuration, wherein the variation is not present in the pre-defined configuration; and
determining an adjustment to the weld based on the variation.

13. The method of claim 10, further comprising:
adjusting one or more settings of a welding device based on the adjustment;
wherein the welding device is being utilized to perform the weld.

14. The method of claim 11, wherein the adjustment is a change of current of the welding device.

15. The method of claim 11, wherein the adjustment is a change in weld type.
